(19) United States
(12) Patent Application Publication
(10) Pub. No.: US 2015/0228211 A1
(43) Pub. Date: Aug. 13, 2015

(54) DEVICE FOR PRESENTING INFORMATION CARRIERS

(71) Applicant: NOVOMATIC AG, Gumpoldskirchen (AT)

(72) Inventor: Andrija Curic, Wien (AT)

(21) Appl. No.: 14/417,926

(22) PCT Filed: Aug. 1, 2013
(86) PCT No.: PCT/EP2013/002301

§ 371 Date: Jan. 28, 2015

(30) Foreign Application Priority Data
Aug. 2, 2012 (DE) 20 2012 007 466.0
Aug. 10, 2012 (AT) A 50317/2012

(51) Int. Cl. G09F 13/18

(52) U.S. Cl. CPC G09F 13/18; G09F 2013/184; G09F 2013/1845; G09F 2013/1881

(57) ABSTRACT

A device for presenting information carriers, such as posters, pictures, advertisements, and the like, having at least one transparent carrier plate, onto which an information carrier, preferably in the form of foil, film, or sheets can be mounted, a frame surrounding the carrier plate, and an illumination device attached to the frame for illuminating and/or backlighting the information carrier. The frame includes a lateral frame opening, by way of which the carrier plate to which the information carrier is attached can be pulled out/inserted into the frame in a direction that is parallel to the frame plane defined by the frame. The device is characterized in that the frame opening can be locked by way of a removable frame part, which can be detachably connected to the remaining frame parts such that the frame encompasses the information carrier on all sides when the frame opening is locked.

The present invention relates to a device for presenting information carriers such as posters, images, advertisements and the like, having at least one transparent carrier plate on which an information carrier, preferably in the form of a foil, film or sheet, may be mounted, a frame surrounding the carrier plate, and an illumination device which is mounted on the frame, for illuminating and/or backlighting the information carrier, wherein the frame includes a lateral frame opening through which the carrier plate, together with the information carrier mounted thereon, may be withdrawn from/inserted into the frame in a direction parallel to the frame plane that is defined by the frame.

In order to present images, posters or other information carriers such as text or advertising flyers brightly and in high contrast with the surroundings, thin information carriers such as foils, single-ply or multi-ply film materials or sheet-like materials such as partially transparent papers may be printed on or provided with the image or text data in another manner and a suitable illumination device may be shone through them. The said information carriers in the form of foil, film or sheet may in this case be arranged on a transparent carrier plate made for example of glass or plastics such as Plexiglas in order to spread them out smoothly or to avoid undulations or folds in the information carrier, wherein the backlighting or illumination of the information carrier may be performed through the said carrier plate. Where appropriate, the image or text data may also be applied directly to the said carrier plate by a suitable printing method, such that the printing then forms the information carrier that is mounted on the carrier plate.

With backlightable displays or showcases of this kind, hitherto it has been difficult to replace the information carriers to be presented, since the information carriers and where appropriate the associated carrier plate have to be disassembled, in more or less complex and painstaking manner, from a frame that surrounds the carrier plate, and a new information carrier has, where appropriate while tensioning it, to be reassembled on the carrier plate and reinstalled in the frame. This replaceability of the information carrier may be particularly difficult if the information carrier and the associated carrier plate have to be positioned with relative precision in relation to the illumination device in order to achieve exact coupling of the light emitted by the illumination device or an even illumination of the information carrier. The said illumination device may be mounted on the said surrounding frame and in such cases may for example be constructed such that the emitted light is fed into the relatively narrow peripheral side of the carrier plate, with the result that even comparatively small errors of alignment during reassembly can have a perceptible adverse effect on the quality and effectiveness of backlighting of the information carrier.

U.S. Pat. No. 7,942,542 B1 discloses an illuminable showcase of the said type, in which the information carrier is inserted into a frame and the illumination device includes a plurality of LEDs whereof the light output is made even by means of an illumination panel which has a reflector foil applied to its rear side and which is positioned behind the image or information foil through which light is to be shone. In this case, the said information carrier is arranged between two frame parts which are placed on one another, together with a front glass panel and the said illumination panel, in the manner of a sandwich. So that the images through which light is to be shone can be replaced, the said sandwich structure has to be dismantled into a comparatively large number of individual parts, wherein on reassembly the components have to be aligned exactly with one another and in particular a straight and not skewed insertion of the image foil is markedly difficult to perform.

WO 2010/141381 A2 discloses an illuminable image frame which is mounted on the headboard panel of a bed, wherein the frame is constructed to be open or to have a frame opening at an upper side, with the result that the image carrier can be withdrawn upward out of the frame. In order to keep the image carrier in the frame, the lower shank of the frame and the two lateral frame shanks, which together form a U, are provided on the inner side with a plurality of mutually spaced guide profiles in the form of rails or webs, between which the image carrier can be inserted. However, dust and dirt that penetrate into the interior of the frame through the upper side of the frame, which is open for the purpose of replacing images, can have an adverse effect on the illumination device and hence over time impair the brightness of the backlighting of the information carrier to be presented. Moreover, the frame has a tendency to instability, which can have an adverse effect on precise feeding of light into the transparent carrier plate.

Further, U.S. Pat. No. 5,987,794 discloses a display system in which a display cartridge in the form of an LED panel or the like may be inserted laterally into a frame which, for this purpose, has a frame door that is articulated to be laterally pivotal. However, this frame construction is relatively complicated. Moreover, each display cartridge needs its own illumination system.

Taking this as a starting point, the object of the present invention is to provide an improved illuminable device of the type mentioned at the outset which avoids at least one or the other disadvantage of the prior art and develops the latter further in an advantageous manner. In particular, a simple showcase construction that is inexpensive to manufacture is to make it possible to replace the information carrier rapidly and with simple handling without consequently having to sacrifice backlighting or illumination of the information carrier that provides strong illumination and is efficient from the point of view of illumination engineering.

According to the invention, the stated object is achieved by a device as claimed in claim 1. Preferred embodiments of the invention form the subject matter of the dependent claims.

It is thus proposed that the frame be constructed in multiple parts and that a lateral part of the frame be of removable construction, with the result that the carrier plate, together with the information carrier, can be withdrawn laterally from the frame and/or that another information carrier, together with the carrier plate, can be inserted, as a result of which image replacement or information replacement may be performed quickly. According to the invention, the device is characterized in that the frame opening may be closed by a removable frame part which is detachably connectable to the remaining part of the frame, with the result that the frame surrounds the information carrier on all sides when the frame opening is closed. All that needs to be done is to remove the removable frame part in order to be able to replace the information carrier, together with the carrier plate, wherein only the removed frame part has to be put back in place once the replacement is complete. When the frame part is assembled into place again, the frame opening is closed again and the frame surrounds the information carrier on all sides, with the result that the latter is trapped in the frame and cannot fall out. At the same time, the information carrier and the illumination device are protected within the interior of the frame from the penetration of dust, dirt and the like through the frame opening. In particular with a frame opening that is arranged on the upper side of the frame, it is useful that the carrier plate, together with the information carrier, is not only covered at the front side by a frame bezel but is also surrounded on the narrow peripheral side and covered from above, with the result that no dust can trickle in. In addition, when the frame part is assembled into place again, the frame has the increased rigidity of a peripheral frame profile. Taking apart a sandwich structure, including loosening a plurality of screws, and making the adjustment necessary of a plurality of components during reassembly can be dispensed with. In particular, it is also possible for the illumination device to remain in its provided, assembled place, as a result of which errors of positioning and alignment during reassembly and hence an impairment of the backlighting can be avoided. At the same time, the frame is characterized by a simple constructional layout which can be manufactured inexpensively.

In an advantageous further development of the invention, the removable lateral frame part comprises an entire frame shank, wherein the point of parting from the remaining part of the frame may lie in the region of the transition to the adjoining frame shanks, for example such that the ends of the removable frame part and the ends of the remaining parts of the frame that adjoin it are each mitered to fit. As an alternative, however, the removable frame part may also include more than just one frame shank, for example also including a respective portion of a frame shank adjoining it, with the result that for example in the case of a rectangular frame a U-shaped frame part is removable. This may be advantageous, for example in order also to be able to grasp laterally the carrier plate that is to be withdrawn.

The part of the frame that remains when the frame part is removed may be constructed in multiple parts, in particular including a plurality of mutually connected frame shanks which, together with the removable frame part, may in their entirety form a peripherally closed frame. The removable part of the frame may in this case be detachably connected to at least one of the remaining portions of the frame, in order to join the frame together or to close the frame opening, in particular being detachably connected to end sections of the two adjoining frame portions which delimit the frame opening between them. As an alternative or in addition, the removable part of the frame may also be connected to a frame carrier onto which the part of the frame that remains when the frame part is removed may be assembled.

So that the portions of the frame that remain when the frame part is removed still have sufficient structural rigidity, and/or to simplify the securing and positioning of the removable frame part, in a further development of the invention a preferably plate-shaped frame carrier may be provided, for example in the form of a chipboard or a plywood board, but where appropriate also in the form of a fretwork-type panel profile or a plastics panel, the frame parts being secured to this frame carrier. The removable part of the frame may be detachably secured to the said frame carrier, in which case suitable detachable securing means, for example in the form of at least one screw, or indeed detachable quick-acting securing means, for example in the form of form-fittingly acting clamping levers, as are known per se in the furniture sector, may be provided. For example, it may be sufficient to secure the removable part of the frame, in particular if this comprises a frame shank, to the frame carrier solely by means of a screw. If the ends of the frame shank are mitered, then tightening just one centrally mounted securing screw will cause the frame parts to fit one another. As a result of this, only one screw needs to be loosened and the frame part removed, then the information carrier, together with the carrier plate, replaced and the frame part placed on again and the screw tightened in order to replace the motif to be presented.

In an advantageous further development of the invention, it is possible to provide in the frame an inner frame that is preferably arranged such that it is hidden and is constructed separately from the frame and on the one hand holds and/or positions the carrier plate, together with the information carrier connected thereto, and on the other carries the illumination device or at least the illumination means thereof in such a way that it is ensured that the carrier plate is positioned exactly in relation to the illumination device. This is particularly useful if the illumination device feeds the light that it emits into the carrier plate from the edge, over the peripheral side, since in this case even small errors of alignment would result in significantly impaired illumination performance.

The said inner frame may extend along a plurality of sides of the frame, for example forming a U-shaped inner frame, or indeed may comprise only one or more carrier profile parts which may be arranged on one or more frame sides, for example such that two carrier profiles are used on opposing sides of the parts of the frame that remain when the frame part is removed, and these two carrier profiles keep the carrier plate, together with the information carrier mounted thereon, on opposing sides, and carry illumination means on opposing sides in order to illuminate the carrier plate and the information carrier from opposing sides. As an alternative or in addition, a carrier profile may also be provided on a third side, for example a side of the frame opposite the removable part of the frame.

The carrier profile, which is constructed separately from the frame, may in principle be of a different construction, wherein the carrier profile advantageously includes on the one hand positioning means for positioning the transparent carrier plate and/or on the other an illumination means bearing section for bearing illumination means of the illumination device, wherein the said positioning means for the carrier plate and the illumination means bearing section are constructed integrally with one another, in one piece, in order to avoid errors of alignment in multiple-part constructions. The illumination means are positioned directly on the carrier plate, with no tolerance for positioning. In particular, the said carrier profile that is mounted on the frame may include a receiving pocket that is inwardly open, toward the transparent carrier plate, in particular being groove-shaped, for receiving the carrier plate. So that light may be introduced into the said carrier plate by way of the peripheral side of the carrier plate that is seated in the said carrier pocket, the said receiving pocket may include on its base light entry cutouts or base cutouts, or may include an open, for example slotted, base, with the result that illumination means below the base can shine onto the peripheral side of the carrier plate.

Advantageously, the carrier profile may include, below the said receiving pocket for the carrier plate, a receiving space for the illumination means of the illumination device, wherein the said receiving space for the illumination means may be separated from the receiving pocket for the carrier plate by lateral guide or holding webs on which the carrier plate may stand upright by means of its peripheral side.

In an advantageous further development of the invention, the said carrier profile for bearing the illumination means and for positioning the carrier plate may take the form of an extruded profile, for example in the form of a lightweight metal strip.

The said separate carrier profile or the inner frame formed thereby may be rigidly secured to the frame, in particular the parts of the frame that remain when the frame part is removed, but in particular it is also possible—as an alternative or in addition—for it to be secured to the plate-shaped frame carrier, for example being glued and/or screwed thereto.

Depending on the construction of the frame, the said carrier profile may be positioned or mounted at a different point in relation to the frame, wherein in an advantageous further development of the invention a countersunk arrangement or one which is masked behind the frame and which from the intended point of observation is not visible may be provided. In particular, the said carrier profile may be arranged in a frame pocket which is delimited on the one hand by a marginal web that surrounds the carrier plate at the front and on the other by the abovementioned frame carrier plate or frame carrier.

In an advantageous further development of the invention, the frame, advantageously including the removable frame part, may comprise a cross-sectional profile which in cross section is substantially U-shaped or three-limbed and which includes two marginal webs that project toward the frame inner side or the carrier plate and that surround the inserted carrier plate on opposing sides, that is to say the front and rear side, or cover an edge strip of the carrier plate. Thus, the frame may have, between the said two marginal webs, a U-shaped or groove-shaped cutout into which the carrier plate extends by means of edge end sections. In order to achieve simple handling with no risk of wrinkling and no separate assembly steps, but in order also to promote even and efficient illumination, in a further development of the invention it is provided for the information carrier which is preferably in the form of a foil, film or sheet to be connected to the transparent carrier plate over its entire surface, wherein the information carrier may advantageously be laminated onto the front side of the carrier plate. Lamination of this kind may in principle be achieved in various ways, in particular with the aid of suitable laminating means such as lacquer, glue, wax or adhesive, wherein depending on the information carrier used where appropriate a heat lamination may also be provided, that is to say the information carrier may be mounted on the carrier plate using heat and/or pressure.

In this case, an example of an information carrier that may be used is a so-called Duratrans film, as offered for example by Kodak.

In order to achieve bright illumination of the information carrier by shining light through it, in this case advantageously the information carrier may be arranged on a front side of the carrier plate, while the carrier plate may be of a construction providing total reflection on its rear side and/or provided with a reflective coating, with the result that light that is fed into the carrier plate by way of a peripheral side of the carrier plate cannot escape by way of the rear side of the carrier plate but can only exit through the front side or pass through the information carrier. As a result, a bright and luminous image of the information carrier can be generated using relatively little illumination power.

The illumination device may in principle take various forms and may in particular include a plurality of LEDs, which may be arranged distributed on the frame, along the peripheral edge of the carrier plate. In particular, an LED strip may be inserted into the abovementioned separate carrier profile or arranged on the latter.

Depending on the purpose for which it is to be used, the device may have only one viewing side, for example if it is a design capable of being mounted on a wall. In an advantageous further development of the invention, however, the device may also take a double-sided form or have two viewing sides which are in particular arranged opposite one another, for example if it is a showcase that may be set up to be free-standing. In an advantageous further development of the invention, a double-sided showcase of this kind may include two carrier plates that are each provided on their front side with an information carrier and may be arranged to have their rear sides turned toward one another. In particular, the said two carrier plates may be arranged on opposite sides of the abovementioned frame carrier, which may take the form of a panel, with the result that the said frame carrier lies between the two transparent carrier plates.

In this case, the frame is advantageously constructed such that the removable frame part extends over both carrier plates, with the result that removing the said frame part in the abovementioned way enables both carrier plates to be replaced.

The removable frame part may in this case advantageously be removed entirely from the remaining part of the frame, with the result that there is no longer a connection between the said frame parts. As an alternative, the removable frame part may be connected to the remaining part of the frame and/or the abovementioned frame carrier by a pivotal joint, and this pivotal joint enables the removable frame part to be pivoted between a position that closes the frame opening and a position that exposes the frame opening.

Advantageously, for the purpose of pivotally bearing the removable frame part, the said pivotal joint may have a pivot axis that can extend substantially perpendicular to the frame plane and/or substantially perpendicular to the longitudinal extent of the removable frame part, with the result that the removable frame part may be pivoted away in order to expose the frame opening. Pivoting away the removable frame part in this manner advantageously allows the frame opening to be exposed substantially entirely, with the result that unhindered access to the frame opening and hence simple replacement of the information carrier is possible.

The present invention will be explained in more detail below with reference to preferred exemplary embodiments and associated drawings. In the drawings:

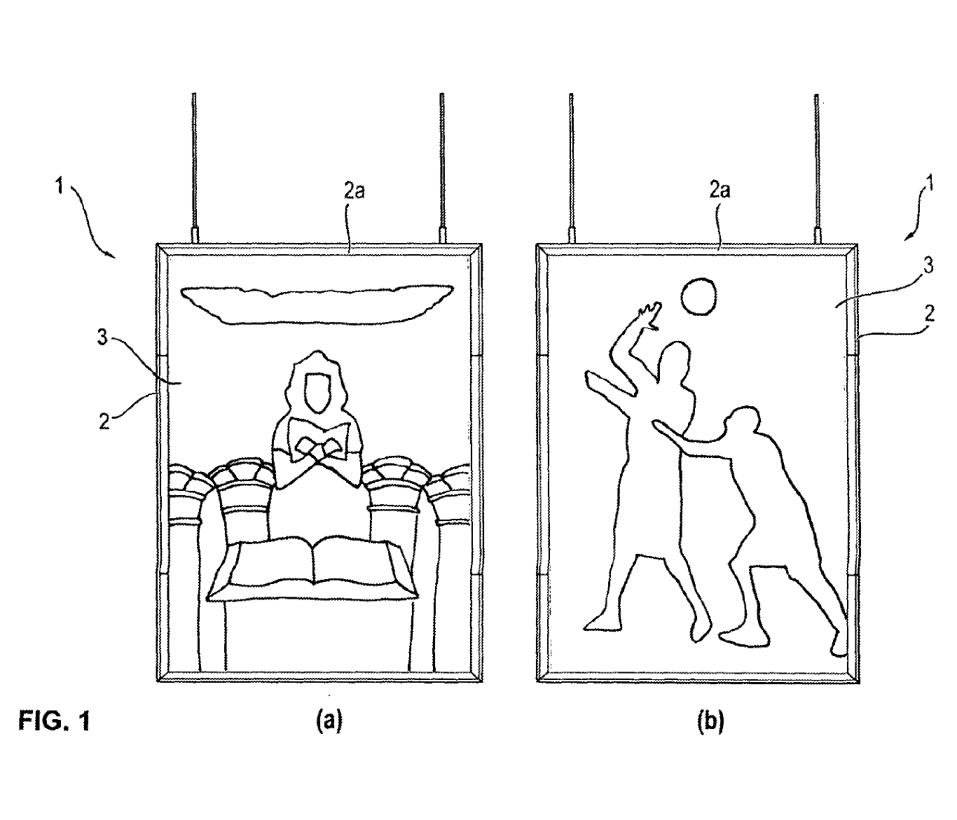

FIG. 1 shows a plan view of an illuminable device for presenting information carriers, of an advantageous embodiment of the invention, wherein part views (a) and (b) show the information carriers, which are different on the front and rear sides of the device,

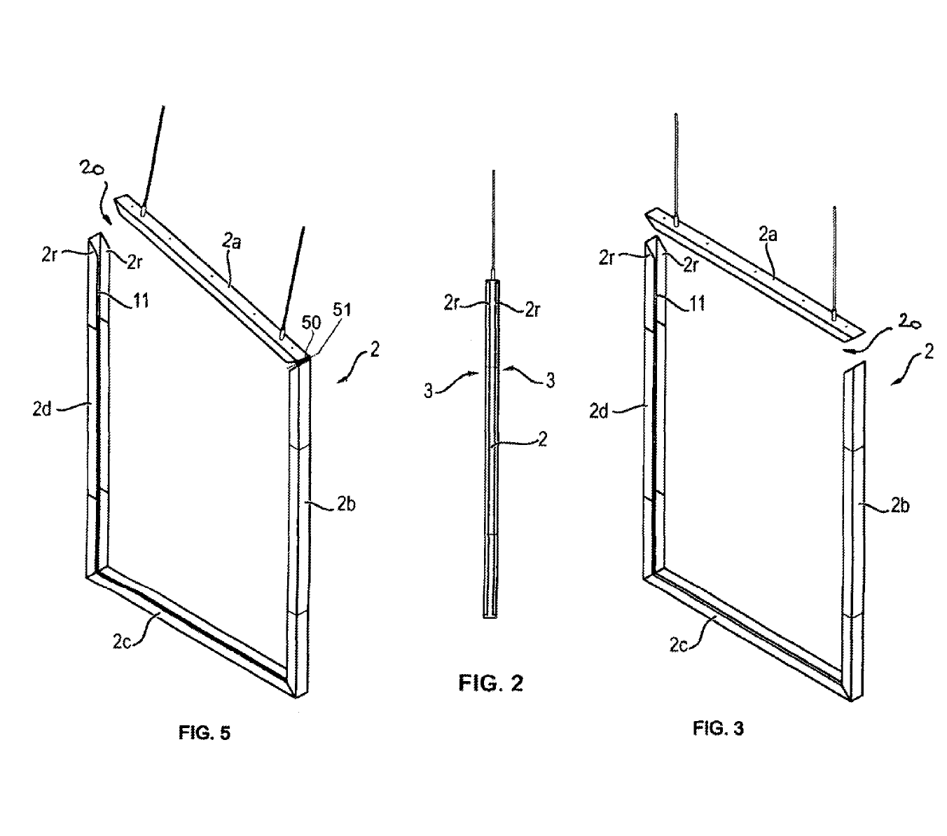

FIG. 2 shows a side view of the device from FIG. 1,

FIG. 3 shows a perspective illustration of the frame of the device from the preceding figures, wherein the removable frame part in the form of the upper frame shank is shown removed,

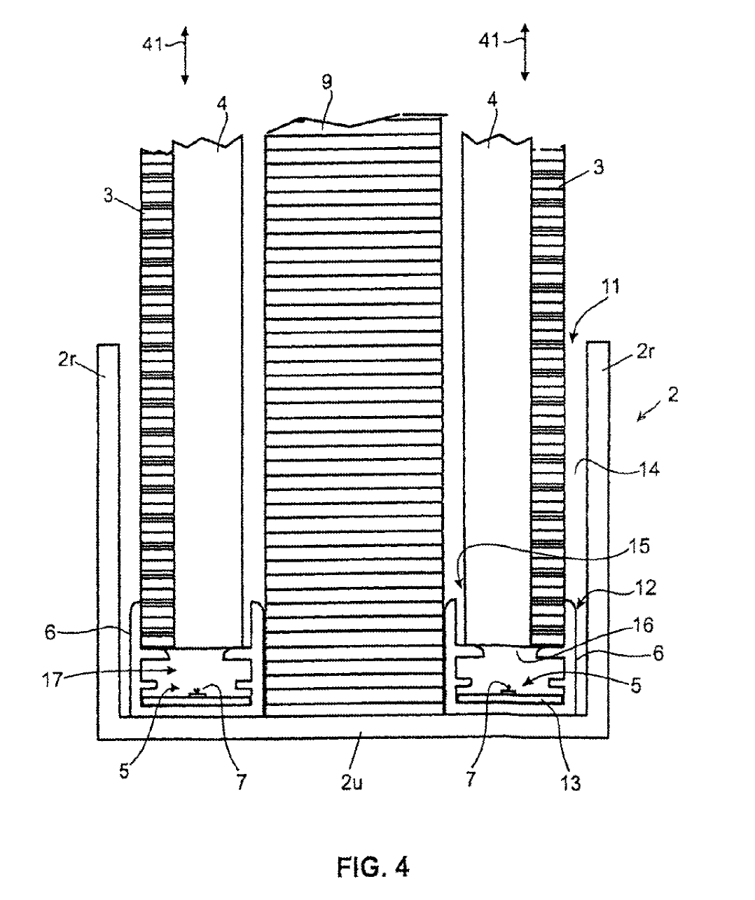

FIG. 4 shows a sectional view through the device from the preceding figures in the region of its frame, wherein there are shown the frame, which is U-shaped in cross section, the frame carrier plate that holds the frame parts together, the transparent carrier plates that are inserted on either side of the said frame carrier plate with information carrier foils laminated thereto, and the separate carrier profiles for positioning the transparent carrier plates and the illumination device, and

FIG. 5 shows a perspective illustration of the frame of the device similar to FIG. 3 and according to a further embodiment of the invention, according to which the removable frame part in the form of the upper frame shank may be pivoted away.

As FIGS. 1 to 3 show, a device for presenting information carriers, which may take the form of a showcase 1, according to an exemplary embodiment of the invention has a peripherally closed frame 2 that is polygonal, in particular rectangular, in form and includes a plurality of frame shanks that form the different sides of the frame. Instead of the rectangular shape illustrated, the frame 2 may also have other shapes, for example being hexagonal or rounded, for example in the form of an oval, or contoured in the manner of a coat of arms.

In the present case, the frame shanks are formed by frame portions 2a, 2b, 2c and 2d of the frame 2. The frame portions 2a-2b are secured, for example being screwed tight, to a plate-shaped frame carrier 9, for example in the form of a chipboard or plywood board or edge-glued board or a plastics panel. The frame carrier 9 extends in the plane defined by the frame 2 and is aligned approximately centrally in cross section in relation to the said frame portions 2a, 2b, 2c and 2d, with the result that the said frame portions 2a to 2d extend on both flat sides of the frame carrier 9. For example, a symmetrical arrangement of the frame carrier 9 in cross section of the said frame portions 2a to 2d may prove advantageous.

On both sides of the said frame carrier 9 there is provided a respective carrier plate 4 made from transparent material such as Plexiglas, and these each extend over substantially the entire surface enclosed by the frame 2 and, in an edge region, are surrounded or covered by marginal webs 2r of the frame 2. As shown in FIG. 4, the frame 2 may have a U-shaped cross-sectional contour, in which case two marginal webs 2r project inward from a peripheral web 2u, that is to say toward the spatial region enclosed by the frame 2, with the result that the frame 2 as a whole defines a peripheral inner groove 11 that is inwardly open (that is to say toward the inside of the frame). The abovementioned frame carrier 9 and the two carrier plates 4 are received in the said inner groove 11.

As FIG. 4 further shows, each of the said carrier plates 4 is provided on its front side, that is to say the side remote from the frame carrier 9, with an information carrier 3, for example in the form of a translucent or transparent foil, and the image or text data to be represented is printed onto this information carrier 3, as shown by the part views (a) and (b) of FIG. 1.

The said information carrier 3 in the form of a foil or film is in this case advantageously connected to the respective carrier plate 4 over its entire surface, in particular being laminated thereto.

In order to backlight or to shine light through the information carrier 3, an illumination device 5 is integrated into the frame 2, and this illumination device 5 may be arranged on the base of the U-shaped cross-sectional contour of the frame 2, as shown in FIG. 4. The said illumination device 5 may in this case be a plurality of illumination means 7, for example in the form of light-emitting diodes LEDs, which may be arranged distributed along the frame 2. The said LEDs may for example be in the form of an LED strip that is laid along the inner groove 11 of the frame 2. It should be mentioned that the illumination means 7 may be formed by other known light sources.

As FIG. 4 shows, for positioning the illumination device 5 and also for positioning the carrier plates 4, together with the information carriers 3 laminated onto them, a respective inner frame in the form of a separate carrier profile 6 may be provided, and this may extend in certain sections or entirely along the peripheral contour of the frame 2, in particular being inserted into the said frame 2. As FIG. 4 shows, the said carrier profile 6 may in each case be inserted into the frame pocket 14 that is formed on both sides of the frame carrier 9 between the said frame carrier 9 and the marginal web 2r of the frame 2 that is spaced therefrom, wherein the said carrier profile 6 may advantageously be seated on the peripheral web 2u of the frame 2; cf. FIG. 4.

The said carrier profile 6 may advantageously take the form of an extruded profile, for example made from aluminum, but where appropriate may also be manufactured in another way. For positioning the transparent carrier plate 4, the said carrier profile 6 includes positioning means 12 that may in particular comprise a groove-shaped receiving pocket 15, which is open toward the inside, that is to say toward the carrier plate 4, and into which the carrier plate 4 may be inserted by means of its edge. The said receiving pocket 15 is constructed to be open at its base or has a slot-shaped base cutout 16, with the result that the receiving space 17 below the receiving pocket 15 communicates with the said receiving pocket 15. The illumination means 7 that are arranged in the receiving space 17 may consequently shine light on the peripheral side of the carrier plate 4 in order to feed light for example into the end face(s) of the carrier plate 4. The base of the said receiving space 17 forms a holding portion 13 for the illumination means 7, in particular it being possible for the LED strip to be arranged or held thereon.

So that the carrier plates 4 can be replaced or exchanged simply, the carrier plates 4 are only pushed against the associated carrier profiles 6 or are arranged such that they may be guided displaceably in the receiving pocket 15, or inserted thereinto and withdrawn therefrom.

To enable the carrier plates 4 to be inserted and withdrawn in a direction parallel to the frame plane defined by the frame 2, the frame 2 is constructed in multiple parts. In the embodiment shown, the frame 2 is constructed in two parts and includes a removable frame part in the form of the removable frame shank 2a. According to FIG. 3, this is the upper frame shank 2a, although a lateral or lower frame shank could also be constructed to be removable.

When the said removable frame shank 2a is disassembled, a frame opening 2o is produced in the frame 2, through which the carrier plate 4, together with the information carrier 3 thereon, can be withdrawn from the frame 2. The said frame opening 2o advantageously extends over an entire side of the frame 2, with the result that the remaining part of the frame defines at least approximately a U-shaped framework by means of the frame shanks 2b, c and d. The length of the frame opening 2o corresponds to at least the maximum dimension of the information carrier 3 and/or the carrier plate 4 in the direction transverse to the direction of insertion and withdrawal in which the information carrier 3 and the carrier plate 4 can be inserted into the frame or taken out of the frame.

As FIG. 3 further shows, the frame parts may be mitered in corner regions at which they adjoin one another so that they can be placed against one another with a precise fit. The removable frame part 2a may for example be secured to the frame carrier 9 by detachable securing means, with the result that it can easily be removed once the said securing means have been loosened. As a result, an open frame side is produced through which the carrier plate 4, together with the information carrier 3 mounted thereon, may be withdrawn from the frame 2 (cf. FIG. 4, direction of motion 41). Once another desired carrier plate 4 and/or another desired information carrier 3 has been inserted, the frame part 2 can simply be placed on again. In an advantageous embodiment, just one individual screw may be provided for the removable frame shank 2a, with the result that the information carrier can be replaced comparatively quickly and simply.

As FIG. 5 shows, the removable frame part 2a may also be mounted pivotally, with the result that it can be pivoted away from the frame opening 2o. The said removable frame part 2a can in this case by borne by means of a pivotal joint 50 that has a pivot axis 51 that extends perpendicular to the frame plane, and/or can be provided at an end section of the removable frame part 2a, in particular between the said end section of the removable frame part 2a and an adjacent—when the frame part 2a is in its attached position—end section of the remaining part 2b of the frame. As a result of the said pivotal joint 50, for example in the form of a hinge, the removable frame part 2a may be directly connected to the remaining part 2b of the frame and/or the frame carrier 9.

The way that the removable frame part 2a is borne pivotally is in this case advantageously of a nature such that the frame opening 2o is substantially exposed when the removable frame part 2a is pivoted away, such that unhindered access to the frame opening 2o and hence simple replacement of the information carrier 3, together with the carrier plate 4, is possible. Further, as shown for example in FIG. 5, a pivotal bearing of the removable frame part 2a makes it possible to close and open the frame 2 in a simple manner. For example, it may be sufficient for the pivotal frame part 2a to be detachably secured at just one point in order to close the frame stably, for example at an end section of the frame part 2a that is opposite the pivotal joint 50 and may be connected to the remaining part of the frame 2d, or at another portion of the frame part 2a that may be fixedly connected to the frame carrier 9. The said detachable connection to the remaining part of the frame 2d and/or the frame carrier 9 may for example be made by a screw, or indeed by a bolt or a closure part, for example in the form of a clip lock that may be brought into holding engagement with the frame part 2a on the one hand and the frame part 2d and/or the frame carrier 9 on the other when the frame part 2a is in the position in which it closes the frame opening 2o, and prevents the frame part 2a from moving pivotally and hence keeps the frame part 2a in the closed position. For example, a sliding or pivotal bolt or a resilient snap-on clip may trap the frame part 2a when it is in the closed position in order to prevent it from opening undesirably.

Furthermore, the entire device may also be kept in the opened condition on the suspension means—which may for example, as shown in FIG. 5, be mounted on the removable frame part 2a—by way of the said pivotal joint 50, with the result that the information carrier 3 may be exchanged in a particularly simple procedure without the suspension means having to be removed or the frame 2 having to be put down or held by a second person for this purpose.

1. A device for presenting information carriers such as posters, images, advertisements and the like, having at least one transparent carrier plate on which an information carrier, preferably in the form of a foil, film or sheet, may be mounted, a frame surrounding the carrier plate, and an illumination device which is mounted on the frame, for illuminating and/or backlighting the information carrier, wherein the frame includes a lateral frame opening through which the carrier plate, together with the information carrier mounted thereon, may be withdrawn from/inserted into the frame in a direction parallel to the frame plane that is defined by the frame, wherein the frame opening may be closed by a removable frame part which is detachably connectable to the remaining parts of the frame, with the result that the frame surrounds the information carrier on all sides when the frame opening is closed.

2. The device as claimed in claim 1, wherein the plurality of frame parts of the multiple-part frame are assembled onto a plate-shaped frame carrier, and this frame carrier is arranged on a rear side of the at least one carrier plate, wherein the removable frame part is detachably secured to the frame carrier and the remaining parts of the frame which remain when the removable frame part is removed is held fixed on the frame carrier.

3. The device as claimed in claim 1, wherein the removable frame part is formed by a frame shank.

4. The device as claimed in claim 1, wherein the part of the frame that remains when the removable frame part is removed is constructed in multiple parts and/or includes a plurality of mutually connected frame shanks, wherein the removable part of the frame may be detachably connected to at least one frame portion of the remaining part of the frame.

5. The device as claimed in claim 1, wherein the frame parts are constructed as frame profile parts that are substantially U-shaped in cross section and cover the transparent carrier plate to front and rear by means of marginal webs, with the result that the said carrier plate is surrounded on three sides, namely to front, rear and periphery, by the frame, wherein the said marginal webs are preferably peripheral in construction and delimit a peripheral frame groove in which the said carrier plate is received by means of an edge.

6. The device as claimed in claim 1, wherein a carrier profile that is constructed separately from the frame is inserted into the frame, and this carrier profile includes positioning means for positioning the transparent carrier plate and an illumination means holding section for holding illumination means of the illumination device.

7. The device as claimed in claim 1, wherein the separate carrier profile is received in a frame pocket that is delimited on the one hand by a marginal web of the frame and on the other by the frame carrier, and is secured at the frame and/or the frame carrier.

8. The device as claimed in claim 1, wherein the separate carrier profile includes a receiving pocket that is inwardly open toward the transparent carrier plate, preferably in the manner of a groove, for receiving the carrier plate, and this receiving pocket includes an open base and/or a base having base cutouts, and a receiving space for receiving the illumination means of the illumination device is provided below this base such that the illumination means are positioned along the peripheral side of the carrier plate and/or light may be shone onto the peripheral side of the carrier plate by the illumination means such that light emitted by the illumination means may be fed into the said carrier plate through the peripheral side of the carrier plate.

9. The device as claimed in claim 6, wherein the carrier profile takes the form of an extruded profile.

10. The device as claimed in claim 6, wherein the carrier profile forms a U-shaped inner frame and/or a plurality of carrier profiles are provided on at least two opposite frame sides, in particular on the part of the frame that remains when the frame part is removed, wherein the inner frame and/or the plurality of carrier profiles form a sliding guide for insertion of the carrier plate together with the information carrier mounted thereon.

11. The device as claimed in claim 1, wherein the information carrier that is preferably in the form of a foil, film or sheet is connected to the carrier plate over its entire surface, in particular being laminated onto a front side of the carrier plate.

12. The device as claimed in claim 1, wherein the information carrier is arranged on a front side of the carrier plate and the carrier plate is of a construction providing total reflection on its rear side and/or is provided with a reflective coating, wherein light coming from the illumination device is fed into the carrier plate by way of a peripheral side of the carrier plate.

13. The device as claimed in claim 1, wherein the illumination device has a LED strip as the illumination means.

14. The device as claimed in claim 1, wherein two transparent carrier plates, on each of which an information carrier which is preferably in the form of a foil, film or sheet may be mounted, may be inserted into the frame with their rear sides turned toward one another.

15. The device as claimed in claim 2, wherein the plate-shaped frame carrier onto which the frame parts are assembled is arranged between the transparent carrier plates and, together with the carrier plates, is surrounded peripherally on three sides, namely to front, rear and periphery, by marginal webs of the frame parts that are U-shaped in cross section.

16. The device as claimed in claim 1, wherein the removable frame part is borne about a pivot axis between a position that closes the frame opening and a position that exposes the frame opening, wherein the said pivot axis preferably extends approximately perpendicular to the frame plane that is defined by the frame and/or approximately perpendicular to the longitudinal axis of the removable frame part, and/or is arranged at an end section of the removable frame part.

17. The device as claimed in claim 1, wherein the removable frame part is connected by a pivotal joint that defines the said pivot axis to the remaining part of the frame and/or the plate-shaped frame carrier.
